(19) United States
(12) Patent Application Publication
(10) Pub. No.: US 2022/0158717 A1
(43) Pub. Date: May 19, 2022

(54) RADIO NETWORK NODE AND METHOD FOR REDUCING ENERGY CONSUMPTION IN A WIRELESS COMMUNICATIONS NETWORK

(71) Applicant: Telefonaktiebolaget LM Ericsson (publ), Stockholm (SE)

(72) Inventors: Pål FRENGER, Linköping (SE); Jonas FRÖBERG OLSSON, Ljungsbro (SE)

(21) Appl. No.: 17/602,834

(22) PCT Filed: Apr. 17, 2019
(86) PCT No.: PCT/SE2019/050358

§ 371 Date: Oct. 11, 2021

(51) Int. Cl. H04B 7/08; H01Q 21/06; H01Q 3/24; H04W 28/02; H04B 7/06

(52) U.S. Cl. CPC H04B 7/0874; H01Q 21/06; H04B 7/0695; H04W 28/02; H01Q 3/24

(57) ABSTRACT

A method performed by a radio network node for reducing energy consumption in communications with wireless devices is provided. The radio network node includes a dual-polarized antenna array, which dual-polarized antenna array has a first sub-set antenna array and a second sub-set antenna array for communication with the wireless devices. The radio network node decides whether to (a) deactivate or (b) not deactivate the second sub-set antenna array, to reduce the energy consumption, based on ongoing communications in the radio network node with wireless devices. The first sub-set antenna array and the second sub-set antenna array have a total antenna pattern that has a deviation that is below a threshold value.

### TECHNICAL FIELD

Embodiments herein relate to a radio network node and methods therein. In particular, they relate to reducing energy consumption in a wireless communication network.

### BACKGROUND

In a typical wireless communication network, wireless devices, also known as wireless communication devices, mobile stations, stations (STA) and/or user equipment (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

Beamforming and 5G

Multi-antenna systems allow transmitting signals that are focused towards certain spatial regions. This creates beams, also referred to as beam forming, whose coverage may reach beyond transmissions using non-beamformed signals but at the cost of narrower coverage. This is a classic trade-off between distance and angular coverage.

In 5G, radio devices are expected to operate with a large number of antennas referred to as Massive MIMO, offering flexibility and potentially very narrow beams, i.e. with very large focusing gain. Massive MIMO makes a clean break with current practice through the use of a very large number of service antennas that are operated fully coherently and adaptively.

Beam Space Transformation

Utilizing multiple antennas at a receiver allows for sampling of a signal over a larger antenna aperture, which increases the overall received power. Further, it allows for coherent combination of multiple copies of the received signal, and hence provides an additional receive beamforming gain in a direction of interest. Since UEs and signals are in general not evenly distributed in space, this may provide a possibility of only processing the signals such as beams which comprises valuable information. Hence, beam space processing with beam selection may provide a complexity reduction.

Channel Estimations

When a signal is sent in a channel, distortion and noise are added to the signal when the signal is transmitted through the channel. To be able to properly decode the received signal without errors, the distortion and noise applied by the channel need to be removed. To do this, the characteristics of the channel is required. The process to characterize the channel is referred to as channel estimation.

The channel estimation procedure includes several steps with different parameters. The channel estimation is traditionally performed on a reference symbol, a pilot signal or training symbols, that are known sequences of information at both Transmission (Tx) and Reception (Rx).

An initial step of the channel estimation is to perform a Match Filter of the received signals with the training sequence, to have a first rough estimate of the channel between the Tx and Rx. Then, various processing algorithms may be applied to improve the estimation, typically some time or frequency-based filtering approach. The goal being to mitigate noise and interference.

Recently 3GPP finalized the Release-15 specification of the 5G New Radio (NR) standard. In NR the radio base station referred to as gNB, may periodically transmit one or more Synchronization Signal Blocks (SSBs). The SSBs may be transmitted in bursts of up to 5 ms duration. In Stand-Alone (SA) operation the SSB burst may periodicity be configured to be 5, 10, or 20 ms and in Non-Stand-Alone (NSA) mode the SSB burst periodicity may also be configured to be 40, 80, or 160 ms, as shown in FIG. 1. The maximum number of SSBs in a SSB burst is 4, 8, or 64 for frequency ranges below 3, 6, and 60 GHz respectively. The SSBs in a SSB burst are referred to as SSB1, SSB2, SSB3, SSB4 . . . etc. in FIG. 1. Each SSB, e.g. SSB1, comprises four Orthogonal Frequency Division Multiplexing (OFDM) symbols. FIG. 1 depicts transmitted control information 191, shown as light grey, and transmitted data 192, shown as dark grey.

To minimize the network energy consumption, it is preferable to use a large SSB periodicity, e.g. 20 ms for SA mode or 160 ms for NSA mode, and a small number of SSBs per burst, e.g. 1, as shown in the lower part of FIG. 1. This is because every additional SSB transmission reduces the Discontinuous Transmission (DTX) ratio and duration. In addition, every SSB may require separate transmission of System Information (SI) and paging. FIG. 1 thus illustrates an example of beam-sweeping configurations for 5G NR with 64 SSB-beams, shown in the top of FIG. 1, and one SSB-beam, shown in the bottom of FIG. 1. More SSB transmissions may typically result in higher idle mode network energy consumption.

A common misconception related to massive MIMO is that with many elements all beams become narrow, and hence beam-sweeping is the only way to achieve wide area coverage with many antenna elements.

This is partly true for single polarized beamforming, but it is not true for dual polarized beamforming as depicted in FIGS. 2a and 2b. FIG. 2a shows an antenna array comprising of single polarized elements, i.e. an antenna pattern from a single antenna element 201 and examples of total antenna patterns 202 for different pre-coders [w₁ w₂ w₃ w₄].

FIG. 2b shows an antenna array comprising of dual polarized elements including partial antenna patterns and the total antenna pattern.

The document US 2012/0212372 A1 discloses a low-complexity construction method to scale a dual-polarized antenna array without changing the total antenna pattern.

The basic principle of dual-polarized and array-size invariant beamforming is illustrated in FIG. 3. As shown in FIG. 3 a companion array is appended to a protoarray, e.g. a prototype array, and a resulting expanded array, e.g. an extended array, is formed, preserving the total radiation pattern of the protoarray. This construction also works with 2D antenna arrays and for other expansion factors than 2. FIG. 3 thus shows an example of how to construct a larger antenna array from a smaller antenna array without affecting the total antenna pattern.

Due to the large number of active components, a large-scale antenna system may consume a large amount of energy. This may result in significant heat dissipation, requiring large passive cooling fans or active cooling fans. Energy consumption thus increases the weight, volume, and cost of the antenna system. In addition, energy cost is a significant part of operator OPEX. Operator OPEX means, when used herein, costs and/or expenses the operator has for running a network where energy consumption cost may be a large part. Energy consumption typically also results in a negative environmental impact, e.g. CO2 emissions. Reducing energy consumption thus brings significant benefits related to ecology, economy, and engineering challenges.

### SUMMARY

An object of embodiments herein is to reduce energy consumption in a wireless communications network.

According to a first aspect of embodiments herein, the object is achieved by a method performed by a radio network node for reducing energy consumption in communications with wireless devices in a wireless communication network. The radio network node comprises a dual-polarized antenna array. The dual-polarized antenna array comprises a first sub-set antenna array and a second sub-set antenna array for communication with the wireless devices. The radio network node decides whether to (a) deactivate or (b) to not deactivate the second sub-set antenna array, to reduce the energy consumption, based on ongoing communications in the radio network node with wireless devices in the wireless communication network. The first sub-set antenna array and the second sub-set antenna array have a total antenna pattern that has a deviation that is below a threshold value.

According to a second aspect of embodiments herein, the object is achieved by a radio network node for reducing energy consumption in communications with wireless devices in a wireless communication network. The radio network node comprises a dual-polarized antenna array. The dual-polarized antenna array comprises a first sub-set antenna array and a second sub-set antenna array for communication with the wireless devices. The radio network node is configured to decide whether to (a) deactivate or (b) not deactivate the second sub-set antenna array, to reduce the energy consumption, based on ongoing communications in the radio network node with wireless devices in the wireless communication network. The first sub-set antenna array and the second sub-set antenna array have a total antenna pattern that has a deviation that is below a threshold value.

The radio network node comprises a dual-polarized antenna array which comprises a first sub-set antenna array and a second sub-set antenna array for communication with the wireless devices as mentioned above. With the realisation that a part of the dual-polarized antenna array, such as the second sub-set antenna array, may be disconnected when there is low ongoing traffic in the communications network, the data may be transmitted only from the first sub-set antenna array. Thereby, by deactivating the second sub-set antenna array, the energy consumption in the radio network node will be significantly reduced.

### BRIEF DESCRIPTION OF THE DRAWINGS

Examples of embodiments herein are described in more detail with reference to attached drawings in which:

FIG. 1 is a schematic diagram illustrating an example of beam-sweeping configurations for 5G NR.

FIG. 2a is a schematic diagram illustrating an antenna array comprising single polarized elements.

FIG. 2b is a schematic diagram illustrating an antenna array comprising dual polarized elements.

FIG. 3 is a schematic diagram illustrating an example of how to construct a larger antenna array from a smaller array without affecting the total antenna pattern.

FIG. 4 is a schematic block diagram illustrating embodiments of a wireless communications network.

FIG. 5 is a flowchart depicting embodiments of a method in a radio node.

FIGS. 6 a and b are schematic diagrams illustrating examples of how an antenna array may be scaled down without affecting the beam-shape.

FIGS. 7 a-c are schematic diagrams illustrating examples when there is a low amount of data to transmit.

FIGS. 8 a-c are schematic diagrams illustrating alternative examples when there is a low/medium amount of data to transmit.

FIG. 9 is a schematic diagram illustrating examples of periodic or a-periodic re-mapping.

FIG. 10 is a schematic diagram illustrating an example of an idle mode energy saving potential.

FIG. 11 a and b are schematic block diagrams illustrating embodiments of a radio node.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

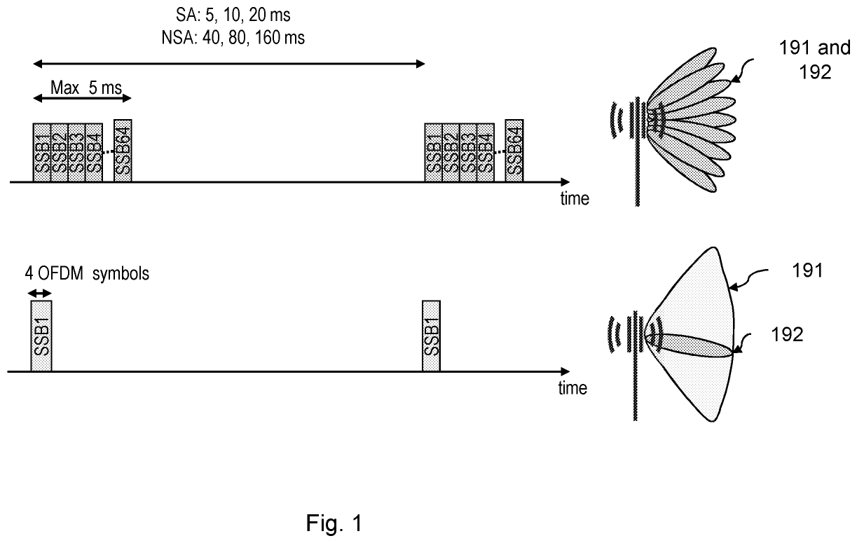

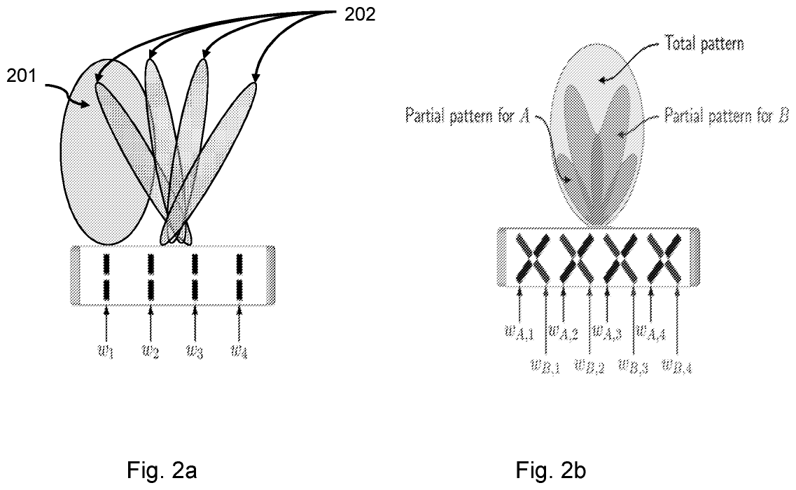

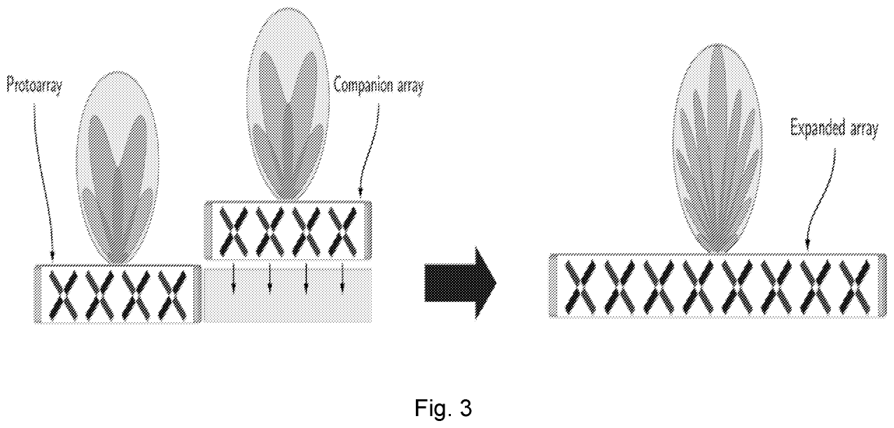

### DETAILED DESCRIPTION

Embodiments herein are based on the insight that a beam generated by the antenna array remains constant even if the antenna array changes in size and it is therefore possible to deactivate a sub-set of the antenna array such that the antenna array is not affecting the beam-shape of a transmission. The deactivating of a sub-set of the antenna array in this way will lead to reduced energy consumption. When the ongoing communications in the radio network node with wireless devices in the wireless communication network is high, i.e. above a threshold value, it is useful to transmit data and control information, e.g. SSB transmissions, SI transmission and paging, from both the first sub-set antenna array and the second sub-set antenna array. However, when the ongoing communications in the radio network node with wireless devices in the wireless communication network is low, i.e. below a threshold value, it is not necessary to transmit data and control information from both the first sub-set antenna array and the second sub-set antenna array. Therefore, in order to reduce the power consumption, the second sub-set antenna array may be deactivated and data and control information may be transferred from the first sub-set antenna array when the ongoing communications in the radio network node with wireless devices in the wireless communication network is low.

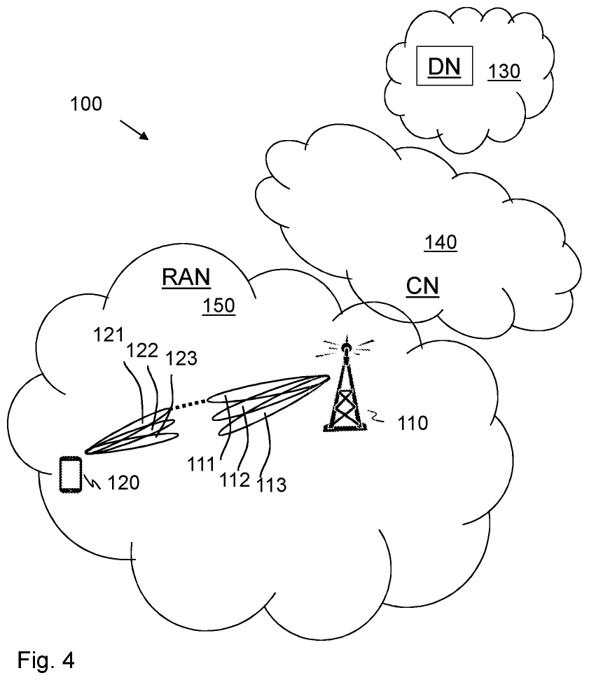

FIG. 4 is a schematic overview depicting a wireless communications network 100 wherein embodiments herein may be implemented. The wireless communications network 100 comprises one or more RANs 150 and one or more CNs 140. The wireless communications network 100 may use 5G NR but may further use a number of other different technologies, such as, W-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the wireless communication network 100, UEs such as one or more wireless devices 120 operate. The wireless device 120 may e.g. be a mobile station, a non-access point (non-AP) STA, a STA, a user equipment and/or a wireless terminals, an NB-IoT device, an eMTC device and a CAT-M device, a WiFi device, an LTE device and an NR device communicating via one or more Access Networks (AN), e.g. RAN, to one or more core networks (CN). It should be understood by the skilled in the art that “UE” is a non-limiting term which means any terminal, wireless communication terminal, wireless device, Device to Device (D2D) terminal, or node e.g. smart phone, laptop, mobile phone, sensor, relay, mobile tablets or even a small base station communicating within a cell.

Network nodes operate in the wireless communications network 100, such as a radio network node 110 providing radio coverage by means of antenna beams, referred to as beams herein.

The radio network node 110 comprises multiple beams such as e.g. a first beam, 111, a second beam 112, and a third beam 113 and may use these beams for communicating with e.g. the wireless devices 120.

The wireless devices 120 may also comprise multiple beams such as e.g. a first beam, 121, a second beam 122, and a third beam 123 and may use these beams for communicating with e.g. the radio network node 110.

The radio network node 110 may e.g. be a base station. The radio network node 110 provides radio coverage over a geographical area by means of antenna beams. The geographical area may be referred to as a cell, a service area, beam or a group of beams. The radio network node 110 may in this case be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within the cell 11 served by the radio network node 110 depending e.g. on the radio access technology and terminology used.

The methods according to embodiments herein are performed by the radio network node 110 which, as mentioned above, e.g. may be any one out of a network node and a wireless device. The radio network node 110 comprises a dual-polarized antenna array 300, not shown in FIG. 4. The dual-polarized antenna array 300 comprises a first sub-set antenna array 310 and a second sub-set antenna array 320 for communication with the wireless devices 120.

As an alternative, a Distributed Node (DN) and functionality, e.g. comprised in a cloud 130 as shown in FIG. 4 may be used for performing or partly performing the methods.

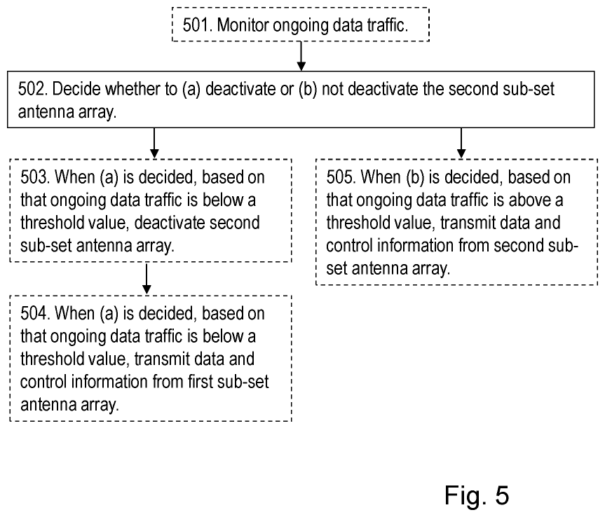

Example embodiments of a method performed by a radio network node 110 for reducing energy consumption in communications with wireless devices 120 in a wireless communication network 100 will now be described with reference to a flowchart depicted in FIG. 5. The radio network node 110 comprises a dual-polarized antenna array 300, which dual-polarized antenna array 300 comprises a first sub-set antenna array 310 and a second sub-set antenna array 320 for communication with the wireless devices 120.

The method comprises the following actions, which actions may be taken in any suitable order. Actions that are optional are presented in dashed boxes in FIG. 5.

Action 501

According to an example scenario, the radio network node 110 monitors ongoing data traffic, i.e. ongoing communications in the radio network node 110 with the wireless devices 120, in the wireless communication network 100. This is because the ongoing data traffic will affect the decision of whether to deactivate the second sub-set antenna array 320 so that the energy consumption may be reduced.

Action 502

Based on the ongoing data traffic, the radio network node 110 decides whether to deactivate or not to deactivate the second sub-set antenna array 320, in order to reduce energy consumption. E.g. when the monitored data traffic is low, i.e. below a threshold value, the radio network node 110 deactivates the second sub-set antenna array 320 and may transfer data and control information from the first sub-set antenna array 310. Thereby the energy consumption is reduced. E.g. when the monitored data traffic is high, i.e. above a threshold value, the radio network node 110 may transmit the data and control information from the second sub-set antenna array 320.

The radio network node 110 thus decides whether to (a) deactivate or (b) not deactivate the second sub-set antenna array 320, to reduce the energy consumption. The decision is based on ongoing communications in the radio network node 110 with wireless devices 120 in the wireless communication network 100. The first sub-set antenna array 310 and the second sub-set antenna array 320 have a total antenna pattern that has a deviation that is below a threshold value. A deviation that is below a threshold value may mean that the integral over a range of angles of antenna gain difference is below a threshold, which may e.g. mean that their total antenna pattern is almost the same. That the first sub-set antenna array 310 and the second sub-set antenna array 320 have a total antenna pattern, e.g. beam-shape that has a deviation which is below a threshold value is advantageous because both the first sub-set antenna array 310 and the second sub-set antenna array 320 provides essentially the same area where wireless devices 120 may be reached, i.e. both provides essentially the same coverage.

Action 503

A large antenna array uses more components than a small antenna array. Therefore, it is useful to deactivate a sub-set antenna array of an antenna array when there is low ongoing data traffic, i.e. the antenna array may be scaled down to deactivate as many components as possible. With the knowledge that a beam generated by the antenna array remains constant even if the antenna array changes in size according to embodiments herein, it is possible to deactivate a sub-set of the antenna array such that the antenna array is not affecting the beam-shape of a transmission. The deactivation of components in the antenna array in this way reduces the energy consumption. Thus, according to some embodiments, when (a) to deactivate the second sub-set antenna array 320 is decided, based on that the ongoing data traffic in the radio network node 110 with wireless devices 120 in the wireless communication network 100 is below a threshold value, the radio network node 110 deactivates the second sub-set antenna array 320. By deactivating the second sub-set antenna array 320 when the ongoing data traffic is low the energy consumption in the radio network node 110 is reduced.

Action 504

When decided that the second sub-set antenna array 320 is to be deactivated, it cannot be used for transmitting data and control information during the time of deactivation. Therefore, according to some embodiments, when (a) to deactivate the second sub-set antenna array 320 is decided based on that the ongoing data traffic in the radio network node 110 with wireless devices 120 in the wireless communication network 100 is below a threshold value, the radio network node 110 may transmit data and control information from the first sub-set antenna array 310. An example of when the ongoing data traffic in the radio network node 110 with wireless devices 120 in the wireless communication network 100 is below a threshold value may e.g. be when the transmission buffer in the radio network node 110 is empty or when it will become empty in a near future, when the number of scheduled resource blocks is zero, when the number of scheduled resource blocks is below a threshold, e.g. a low threshold, when the conditions listed above has been valued for a pre-configured duration of time. The traffic level may also be estimated based on statistical observation of historic traffic. For example, a machine learning and/or artificial intelligence algorithm may be used to determine the likelihood of traffic staying below a threshold for a certain duration of time.

According to some embodiments, when (a) is decided, i.e. when the ongoing data traffic in the radio network node 110 with wireless devices 120 in the wireless communication network 100 is below a threshold value, the transmitting of the data and control information from the first sub-set antenna array 310 may comprise transmitting the data in one part of the first sub-set antenna array 310 and control information in the other part of the first sub-set antenna array 310.

To ensure equal distribution of heat and equal component aging, i.e. that the data and control information is not always transmitted from the same components in the first sub-set antenna array 310, when there is low ongoing data traffic, the transmission of data and control information may be frequently changed. The change of components in the first sub-set antenna array 310 used for transmission may be based on time intervals and may be periodic or aperiodic. It may also be based on temperature sensors in the hardware (HW), e.g. the components that are most cold get activated or, e.g. in case alternative components have cooled down then a re-mapping may be triggered. Therefore, according to some embodiments, components of the first sub-set antenna array 310 are a part of components of the dual-polarized antenna array 300, and the components of the first antenna array 320 are frequently changed to become another part of the components of the dual-polarized antenna array 300. In these embodiments, when (a) is decided, the transmitting of the data and control information from the first sub-set antenna array 310 may be performed divided into time intervals from the first sub-set antenna array 310, each time interval using a changed part of the components of the dual-polarized antenna array 300. This will be explained more in detail below.

When decided that the second sub-set antenna array 320 is not to be deactivated, the second sub-set antenna array 320 may be used for transmitting data and control information. Thus, according to some embodiments, when (b) to not deactivate the second sub-set antenna array 320 is decided based on that the ongoing data traffic in the radio network node 110 with wireless devices 120 in the wireless communication network 100 is above a threshold value, the radio network node 110 may transmit the data and control information from the second sub-set antenna array 320. An example of when the ongoing data traffic in the radio network node 110 with wireless devices 120 in the wireless communication network 100 is above a threshold value may e.g. be when the number of bits in the radio network node 110 transmission buffer is above a threshold; when the radio network node 110 transmission buffer cannot be emptied in a pre-configured time duration; when number of scheduled resource blocks is above a threshold; when any of these conditions have been valid for a preconfigured amount of time.

In some situations the ongoing data traffic may be low but it is decided not to deactivate the second sub-set antenna array 320. Then, according to some embodiments, when (b) is decided based on that the ongoing data traffic in the radio network node 110 with wireless devices 120 in the wireless communication network 100 is below a threshold value, the radio network node 110 may transmit the data from all parts of the second sub-set antenna array 320 and the control information from a part of the second sub-set antenna array 320.

Embodiments herein such as mentioned above will now be further described and exemplified. The text below is applicable to and may be combined with any suitable embodiment described above.

Embodiments herein may comprise a method in a radio network node 110 comprising a dual-polarized antenna array 300 in which mandatory downlink signals and messages, e.g. SSB, SI and paging, are sometimes transmitted from a first sub-set array 310, e.g. a prototype array, and sometimes from a second sub-set array 320, e.g. an extended array.

Embodiments herein may e.g. comprise that:
The first sub-set antenna array 310 is smaller than the second sub-set antenna array 320.
The first sub-set antenna array 310 and the second sub-set antenna array 320 are constructed to have the same total, dual polarized, antenna pattern.
The per-polarization antenna diagrams of the first sub-set antenna array 310 and the second sub-set antenna array 320 are different, e.g. one antenna diagram may point to the left and one antenna diagram may point to the right.
The first sub-set antenna array 310 is primarily used when the user plane traffic is low, i.e. when the ongoing communications in the radio network node 110 with wireless devices 120 in the wireless communication network 100 is low, i.e. below a threshold value.
The second sub-set antenna array 320 is primarily used when the user plane traffic is high, i.e. when the ongoing communications in the radio network node 110 with wireless devices 120 in the wireless communication network 100 is high, i.e. above a threshold value.
Hardware components not utilized in the first sub-set antenna array 310 are deactivated, i.e. the second sub-set antenna array 320 is deactivated in order to reduce energy consumption.

The insight utilized by embodiments herein is that a beam generated by an antenna array, such as the dual-polarized antenna array 300, remains constant even if the underlying antenna array, e.g. the dual polarized antenna array 300, that generates the beam changes in size. This may be utilized to deactivate parts of the antenna array, such as the dual polarized antenna array 300, without affecting the beam-shape used for transmission of mandatory signals, such as the SSB in 5G NR. By deactivation of components in the antenna array in this manner the energy consumption of the gNB may be reduced.

Array Size-Invariant BF and SSB Transmission

By utilizing array size invariant beamforming, an SSB and other non-dedicated signals may be transmitted in a wide-beam even when there are many antenna elements. With only one SSB the idle mode DTX ratio and DTX duration in the network node 110 such as a gNB may be maximized, resulting in low energy consumption.

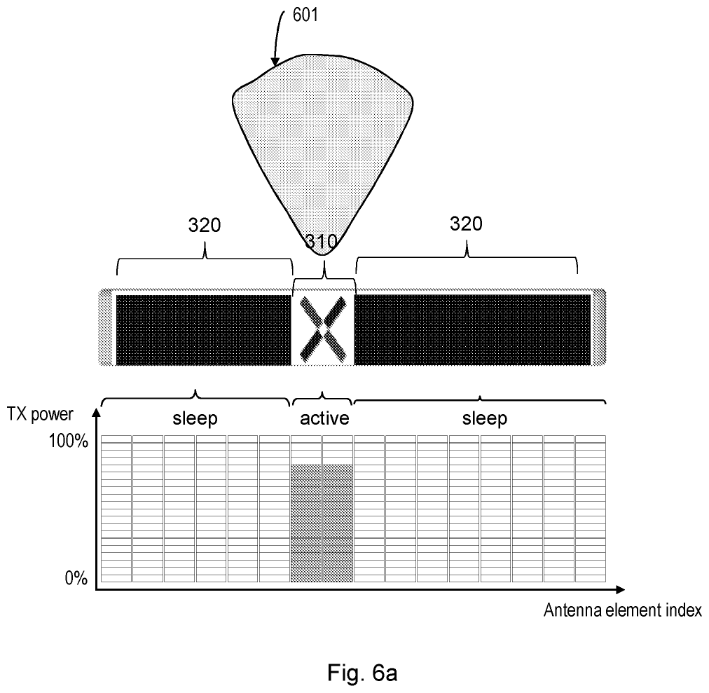

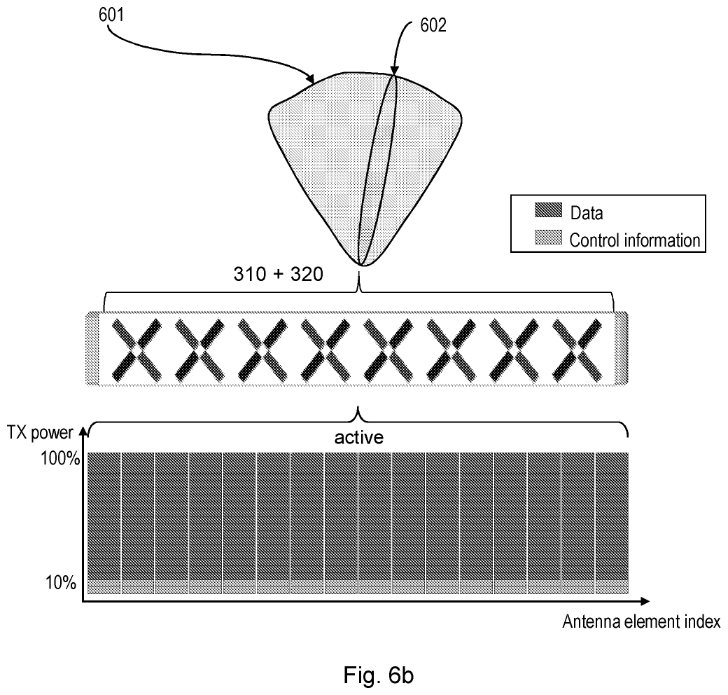

However, with a large antenna array many components are used, such as AD/DA-converters, power amplifiers and filters. To enable that as many components as possible are deactivated during no or low traffic, e.g. ongoing communications between the radio network node 110 and the wireless devices 120, the SSB antenna array, such as e.g. the first sub-set antenna array 310, may be scaled down without affecting the beam-shape of the SSB transmission. This is schematically depicted in FIGS. 6a and 6b.

FIG. 6a shows an example of when control information 601, such as SSB, SI and paging, is transmitted from a reduced array, e.g. the first sub-set antenna array 310. In this example the first sub-set antenna array 310 is active and the second sub-set antenna array 320 being divided into two parts, is deactivated.

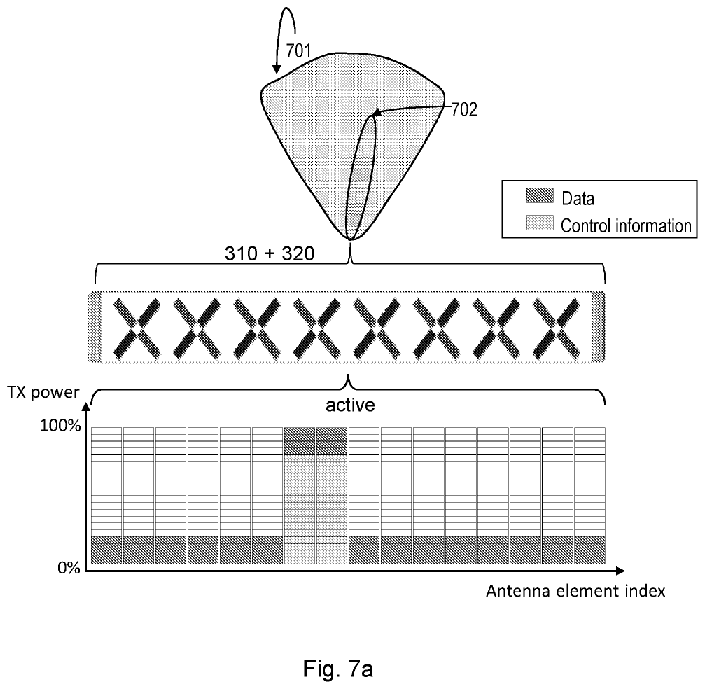

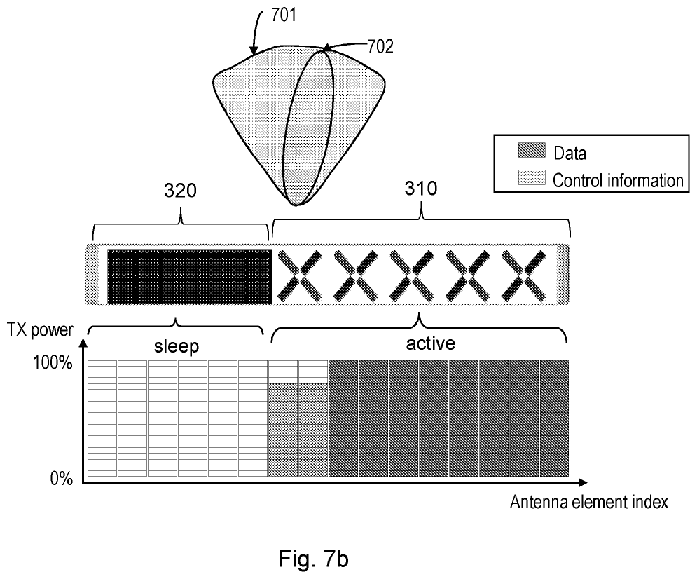

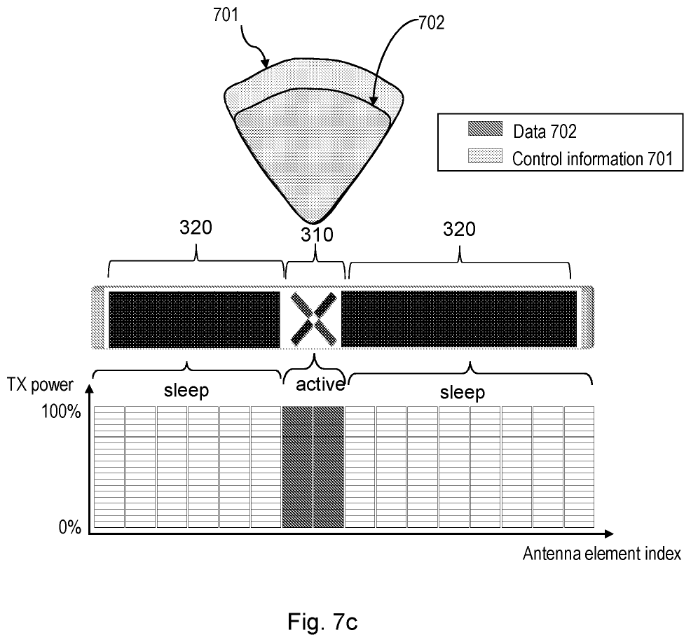

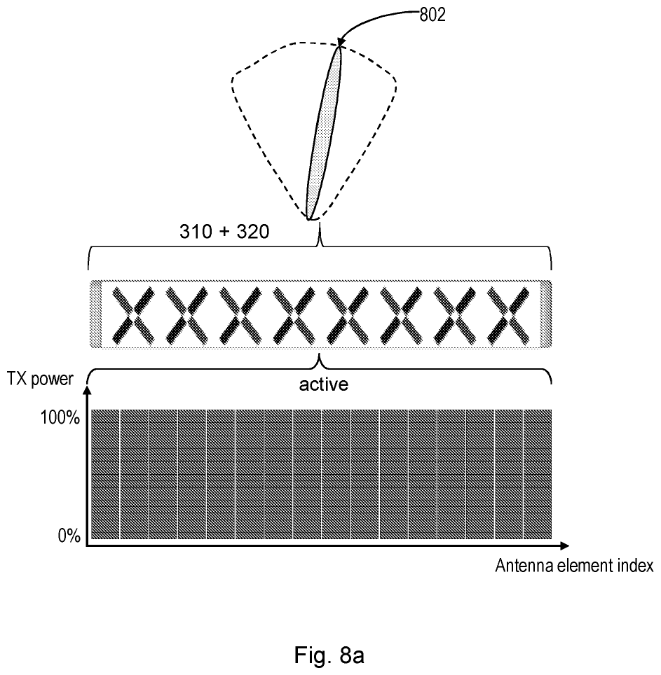

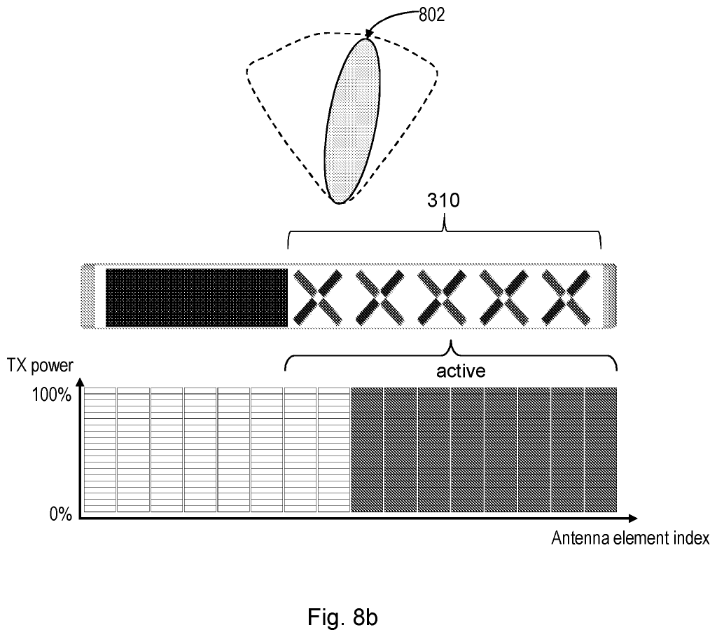

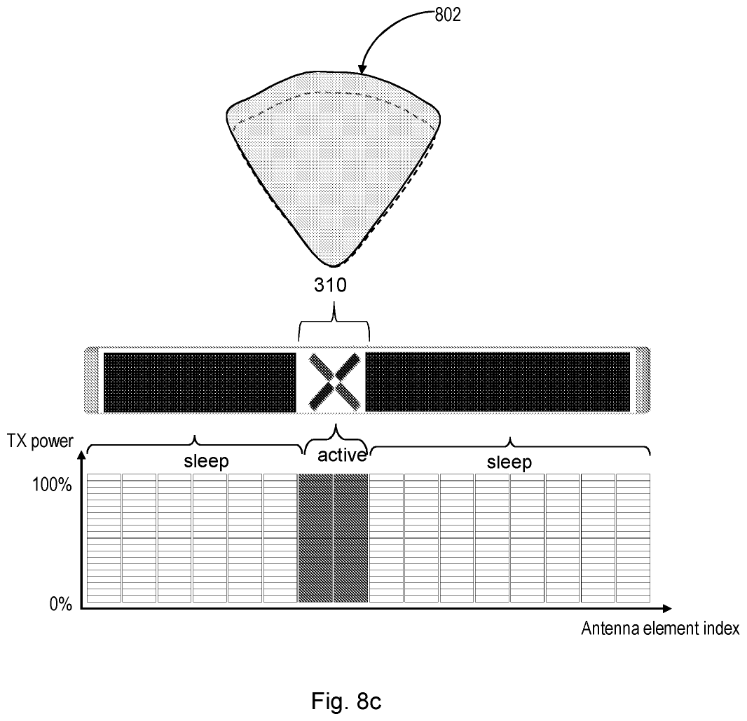

FIG. 6b shows an example of when control information 601, such as SSB, SI and paging, is transmitted from an extended array, e.g. a second sub-set antenna array 320. Thus, here it is decided to not deactivate the second sub-set antenna array 320, which means that both the first sub-set antenna array 310 and the second sub-set antenna array 320 are active. In this example the second sub-set antenna array 320 comprises the second sub-set antenna array 320 and the first sub-set antenna array 310. Transmitted data is shown as dark grey and transmitted control information is shown as light grey in FIG. 6b and also in FIGS. 7a-c, FIG. 8a-c and FIG. 9.

In some embodiments small data transmissions may be performed using a sub-array of the antenna elements, i.e. the second sub-set antenna array 320 will be deactivated.

In case there are active data transmissions in a gNB, e.g. a radio network node 110, then all antenna elements may need to be active to ensure high gain beamforming of the user plane data transmission, as shown in FIG. 6b. To enable an even power load over all antenna elements the SSB beam is transmitted from an extended array. In this example it is assumed that the SSB beam requires 10% of the totally available TX power in the transmission time intervals when it is transmitted.

In case a gNB, e.g. a radio network node 110, has no or very low user plane traffic it is possible to may remap, i.e. transmit control information such as SSB, SI and paging, the SSB beam as depicted in FIG. 6a. In this example the array size is scaled down with a factor of 8, e.g. from 16 elements down to 2 elements, and to compensate for that the power of the remaining antenna branches need to be scaled up with the same factor. This configuration of utilizing a proportionally power-boosted prototype array, e.g. a first sub-set antenna array 310, instead of a full extended array, e.g. a second sub-set antenna array 320, enables deactivation of the majority, e.g. 14 of 16, of antenna element branches without affecting the SSB beam-shape.

FIGS. 7a-c depict examples of configuration when there is a small amount of data 702, shown as dark grey in the examples, to transmit. The assumptions in these examples are that there is a decision not to re-map the SSB beam to the full extended beam. To re-map the SSB beam to the full extended beam when used herein means the SSB beam is created using the antenna elements of the extended antenna array.

If the amount of data that needs to be supported is small it may be beneficial to handle that data without re-mapping the SSB-beam since, doing so will have an impact on the channel of the individual antenna polarizations. This may e.g. impact filtering processes in the wireless devices 120.

In FIG. 7a all antenna branches are activated to support data transmission 702 with a reduced transmission power. The second sub-set antenna array 320 is thus not deactivated in the example shown in FIG. 7a. In this example the second sub-set antenna array 320 comprises the second sub-set antenna array 320 and the first sub-set antenna array 310. Since some of the branches are already highly utilized, e.g. 80% of the power is used for transmitting control information, such as SSB-beam transmissions, in two of the antenna branches in the example shown in FIG. 6a, the power headroom in these branches limits the transmission. But it is still possible to transmit user plane data with a reduced transmission power, e.g. by scheduling only a small number of physical resource blocks for data. FIG. 7a thus depicts transmitted control information 701, shown as light grey, and where data 702, shown as dark grey, is transmitted in a reduced power beam.

FIG. 7b shows an example of re-mapping of the dedicated beams to a smaller number of antenna elements, resulting in reduced beamforming gain. FIG. 7b shows an example of transmitted control information 701, shown as light grey, and where data 702 is transmitted in a wider beam than normal. In this example, the second sub-set antenna array 320 is deactivated and data 702 and control information 701 is transmitted from the first sub-set antenna array 310.

FIG. 7c shows an example of when only the remaining power headroom in the antenna branches used for control information 701 transmissions, such as SSB transmissions, is utilized. In this example the first sub-set antenna array 310 is active and the second sub-set antenna array 320 being divided into two parts, is deactivated.

In all these examples in FIGS. 7a-c, the assumption is that the amount of traffic is low and in that case there should be no degradation in user experience.

The mandatory transmissions in the SSB beams may not be active all the time. In the Transmit Time Intervals (TTIs) when no common signals, i.e. control information, are transmitted, all power headroom on the active antenna branches may be made available for user-plane transmissions, see FIGS. 8a-c which show alternative configurations for low/medium traffic. Common signals may be SSB transmission, system information and paging messages. Also Random Access Response (RAR) transmissions may be treated as common signals. Sometimes broadcast services, such as Multimedia Broadcast Multicast Services (MBMS), may be considered as common signals. The distinction may be if a certain signal is targeting the whole coverage area, in case it is a common signal, or particular wireless devices 120 in which it is not a common signal.

FIG. 8a shows data 802 transmitted in a reduced power beam, e.g. limited number of data PRBs, where both the first sub-set antenna array 310 and the second sub-set antenna array 320 are active. In this example the second sub-set antenna array 320 comprises the second sub-set antenna array 320 and the first sub-set antenna array 310. Transmitted data 802 is shown as dark grey.

FIG. 8b shows data 802 transmitted in wider a beam than normal. In this example, the second sub-set antenna array 320 is deactivated and data 802 is transmitted from the first sub-set antenna array 310. Transmitted data 802 is shown as dark grey.

FIG. 8c shows an example where a small amount of data 802 is transmitted in a beam. In this example the first sub-set antenna array 310 is active and the second sub-set antenna array 320 being divided into two parts, is deactivated. Transmitted data 802 is shown as dark grey.

There are many different scaling steps in between. E.g. for a 64-antenna element antenna panel, the common channels may be transmitted using a sub-array comprising of 32, 16, 8, 4, or 2 antenna elements. Other integer numbers than powers of 2 are possible when extending an antenna array. For better support of wireless devices 120 with a single antenna, the gNB, e.g. the radio network node 110, may be configured to transmitting two SSBs with alternating polarization. The number of active antenna elements in a large array, e.g. a second sub-set antenna array 320, may be adapted to the average data load. In-particular if reactivation of components takes some considerable time to execute then it may be beneficial to scale down the antenna array in multiple steps.

Channel State Information Reference Signals

Channel State Information Reference Signal (CSI-RS) are used for both CSI acquisition and mobility measurements. For CSI acquisition the wireless devices 120 may perform channel estimation based on received CSI-RS and calculates Rank Indicator (RI), Channel Quality Index (CQI) and Pre-coding Matrix Indicator (PMI). For mobility measurements the wireless devices 120 may just estimate the received power of the CSI-RS. When the number of antenna elements are larger than the number of transmission ports supported by the wireless devices 120, the CSI-RS shall preferably be beamformed. The beamforming may be narrow e.g. directed towards a wireless device or wider e.g. directed to an area within the cell where a group of wireless devices are located. Especially for wider-beamformed CSI-RSs used for power measurements, only a sub-array of the antenna elements may be used.

Other Group-Common Signals

The examples of scaling down an antenna panel such as the dual-polarized antenna array 300 to a sub-array, also referred to as a sub-panel, described herein may be applied for any beamformed signal that does not need to be very narrow. As already mentioned the examples may be applied for data and/or control information dedicated to one or more wireless devices 120 at low and/or medium traffic load without impacting user experience. However, the examples may be most beneficial for group common messages and/or signals such as SSB and CSI-RS. In NR there are other group-common signals where the scale-down method may be applied, such as pre-emption indication, slot format indicator, group Transmit Power Control (TPC) commands for Physical Uplink Control Channel (PUCCH), Physical Uplink Shared Channel (PUSCH) and Sounding Reference Signal (SRS).

A Pre-emption Indicator (PI), for example, is a group-common message sent to a group of wireless devices to indicate that one or more Physical Downlink Shared Channel (PDSCH) transmissions were interrupted in indicated Physical Resource Blocks (PRBs) and symbols. The interrupted PDSCH transmissions may each have a narrow beamforming and/or precoding that require all antenna elements of the antenna panel while the single PI message may need to be sent in a wider beam to be able to reach all impacted wireless devices 120. Therefore, the PI message may be sent using only a sub-array, e.g. a first sub-set antenna array 310, of the antenna elements.

Continuous Re-Mapping of Broadcast Beam to Distribute Heat and/or Ensure Equal Component Aging

In some embodiments, the wide broadcast beam, e.g. the beam for SSB, SI, and paging, i.e. control information 901, is always mapped to the same sub-set of antenna elements 903 during low traffic hours, to enable deactivation of antenna branches not used for wide-beam broadcast, then this may e.g. be disadvantageous for local heat concentration and/or un-even rate of component aging, which is illustrated in the left part of FIG. 9. To avoid or minimize this the sub-set antenna array used for wide-beam broadcast during low traffic, i.e. the first sub-set antenna array 310, may be continuously re-mapped to different sets of physical antenna elements 904, which is illustrated in the right part of FIG. 9. The re-mapping may be periodic or a-periodic.

Crude Assessment of Idle Mode Energy Saving Potential

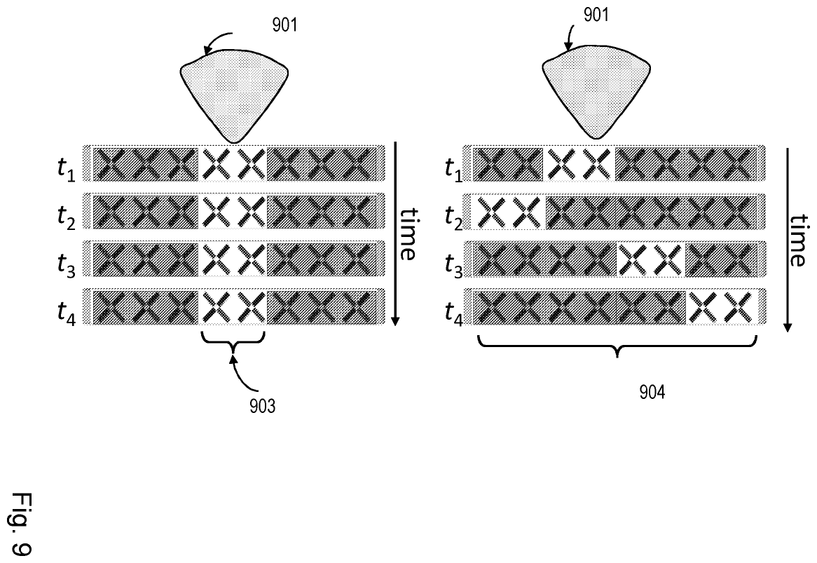

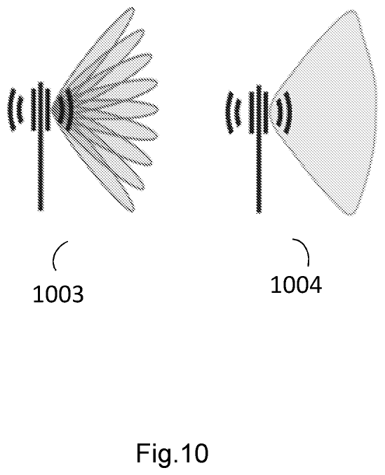

FIG. 10 shows on its left side a reference case with N (N=16 or 32) branches and eight SSB beams 1003. The right side of FIG. 10 shows an energy optimized configuration with two branches active and 1 SSB beam 1004.

To provide some assessment of how large energy savings that may be expected when using the embodiments herein the following very crude assumptions are made: A single SSB is transmitted from two dual polarized antenna branches. Antenna branches that are un-used for SSB transmission are in sleep mode with a sleep factor δ≈0.1, these are comprised in the deactivated second sub-set antenna array 320. The antenna branches used for SSB transmissions are constantly active and these are comprised in the non-deactivated first sub-set antenna array 310. The energy savings depends on the size of the antenna array and the number of SSB blocks in a SSB burst. Assuming eight SSB blocks in a burst and an antenna array of size N=16 and 32 it is possible to expect a reduction in energy consumption with approximately 75% and 81% respectively.

Another advantage of embodiments herein is dynamic optimization, instantly available hardware capability and hardware activation delay based on the ongoing traffic in the communications network, while maintaining constant area coverage of common transmissions.

Further advantages of embodiments herein are:

With reduced energy consumption comes reduces product volume and weight, which simplifies product deployment for the operator and reduces the implementation cost for vendors.

Reduced energy consumption may also have non-linear effects, for example it may be possible to change to a more cost efficient and/or environmentally friendly power supply solution in case the energy consumption falls below a certain level.

Reduced size and weight, which is a direct benefit of reduced energy consumption, of a product may also make new locations potential sites for deploying network equipment.

It is not unlikely that product design decisions are changed because of this type of energy driven miniaturization and this may in turn result in new categories of products.

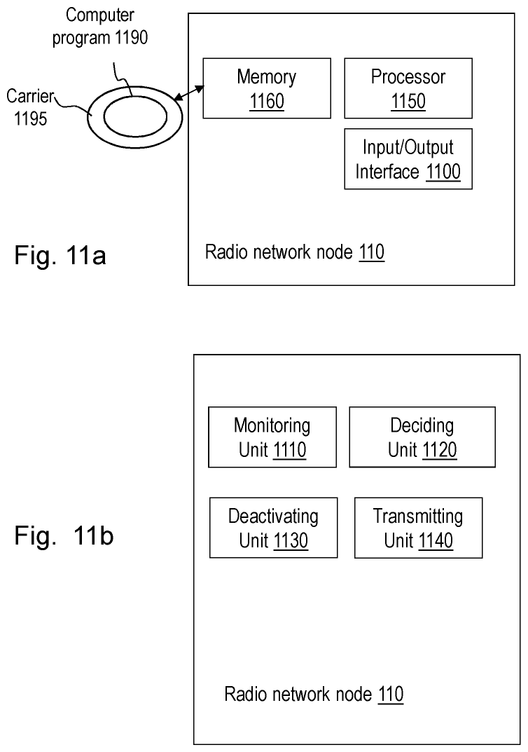

To perform the method actions above for reducing energy consumption in communications with wireless devices 120 in a wireless communication network, the radio network node 110 may comprise the arrangement depicted in FIGS. 11a and 11b. As mentioned above, the radio network node 110 comprises a dual-polarized antenna array 300, which dual-polarized antenna array 300 comprises a first sub-set antenna array 310 and a second sub-set antenna array 320 for communication with the wireless devices 120.

The radio network node 110 may comprise an input and output interface 1100 configured to communicate e.g. with the wireless devices 120. The input and output interface 1100 may comprise a wireless receiver (not shown) and a wireless transmitter (not shown).

The radio network node 110 may be configured to, e.g. by means of a monitoring unit 1110 in the radio network node 110, monitor ongoing data traffic between the radio network node 110 and the wireless devices 120 in the wireless communication network 100.

The radio network node 110 is configured to, e.g. by means of a deciding unit 1120 in the radio network node 110, decide whether to (a) deactivate or (b) not deactivate the second sub-set antenna array 320, to reduce the energy consumption, based on ongoing communications in the radio network node 110 with wireless devices 120 in the wireless communication network 100. The first sub-set antenna array 310 and the second sub-set antenna array 320 have a total antenna pattern that has a deviation that is below a threshold value.

The radio network node 110 may be configured to, e.g. by means of a deactivating unit 1130 in the radio network node 110, when (a) is decided based on that the ongoing data traffic in the radio network node 110 with wireless devices 120 in the wireless communication network 100 is below a threshold value, deactivate the second sub-set antenna array 320.

The radio network node 110 may be configured to, e.g. by means of a transmitting unit 1140 in the radio network node 110, when (a) is decided, based on that the ongoing data traffic in the radio network node 110 with wireless devices 120 in the wireless communication network 100 is below a threshold value, transmit data and control information from the first sub-set antenna array.

According to some embodiments, the radio network node 110 further is configured to e.g. by means of the transmitting unit 1140 in the radio network node 110, when (b) is decided based on that the ongoing data traffic in the radio network node 110 with wireless devices 120 in the wireless communication network 100 is above a threshold value, transmit the data and control information from the second sub-set antenna array 320.

According to some embodiments, the radio network node 110 further is configured to e.g. by means of the transmitting unit 1140 in the radio network node 110, wherein the transmitting of the data and control information from the first sub-set antenna array 310 is adapted to comprise: transmitting the data in one part of the first sub-set antenna array 310 and control information in the other part of the first sub-set antenna array 310.

According to some embodiments, the radio network node 110 further is configured to e.g. by means of the transmitting unit 1140 in the radio network node 110, wherein (a) is decided, and wherein components of the first sub-set antenna array 310 are a part of components of the dual-polarized antenna array 300, and wherein the components of the first sub-set antenna array 310 are adapted to be frequently changed to become another part of the components of the dual-polarized antenna array 300, and wherein:

the transmitting of the data and control information from the first sub-set antenna array 310 is adapted to be performed divided into time intervals from the first sub-set antenna array 310, each time interval using a changed part of the components of the dual-polarized antenna array 300.

According to some embodiments, the radio network node 110 further is configured to e.g. by means of the transmitting unit 1140 in the radio network node 110, when (b) is decided based on that the ongoing data traffic in the radio network node 110 with wireless devices 120 in the wireless communication network 100 is below a threshold value, transmit the data from all parts of the second sub-set antenna array 320 and the control information from a part of the second sub-set antenna array 320.

The embodiments herein may be implemented through a respective processor or one or more processors, such as a processor 1150 of a processing circuitry in the radio network node 110 depicted in FIG. 11a, together with a respective computer program code for performing the functions and actions of the embodiments herein. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as a memory stick. The computer program code may furthermore be provided as pure program code on a server and downloaded to the radio network node 110.

The first radio node 110 may further comprise a memory 1160 comprising one or more memory units to store data on. The memory comprises instructions executable by the processor 1150. The memory 1160 is arranged to be used to store e.g. Synchronization Signal Blocks (SSB), System Information (SI), threshold values, data packets, events, information about the beam-specific signal quality, data, configurations and applications to perform the methods herein when being executed in the radio network node 110.

Those skilled in the art will also appreciate that the units in the radio network node 110 mentioned above may refer to a combination of analog and digital circuits, and/or one or more processors configured with software and/or firmware, e.g. stored in the radio network node 110 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 1190 comprises instructions, which when executed by the respective at least one processor 1150, cause the at least one processor 1150 of the radio network node 110 to perform the actions above.

In some embodiments, a carrier 1195 comprises the computer program 1190, wherein the carrier 1195 is one of an electronic signal, an optical signal, an electromagnetic signal, a magnetic signal, an electric signal, a radio signal, a microwave signal, or a computer-readable storage medium.

Further Extensions and Variations

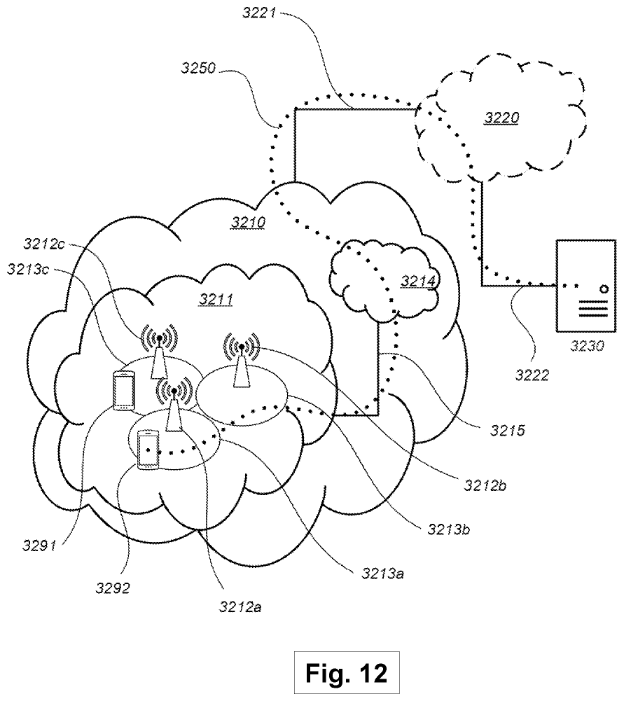

With reference to FIG. 12, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a Non-AP STA 3291 located in coverage area 3213c is configured to wirelessly connect to, or be paged by, the corresponding base station 3212c. A second UE 3292 e.g. the first or second radio node 110, 120 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

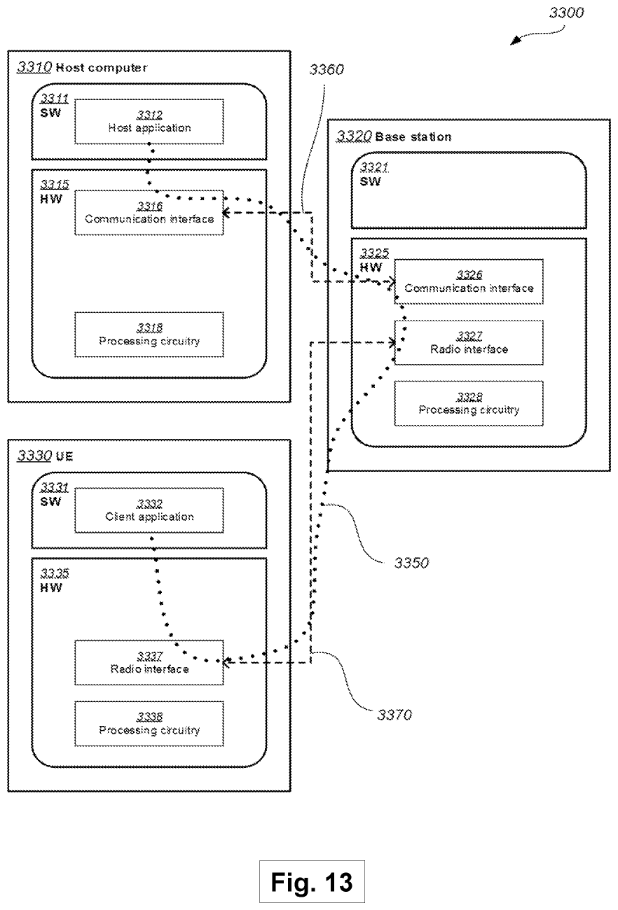

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

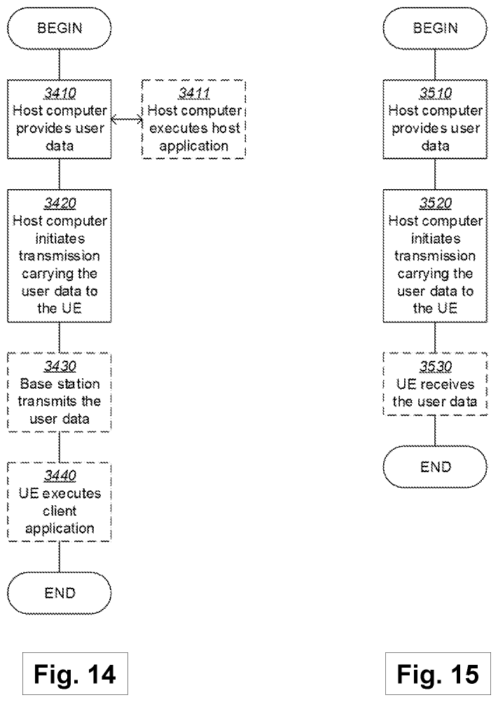

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 8 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

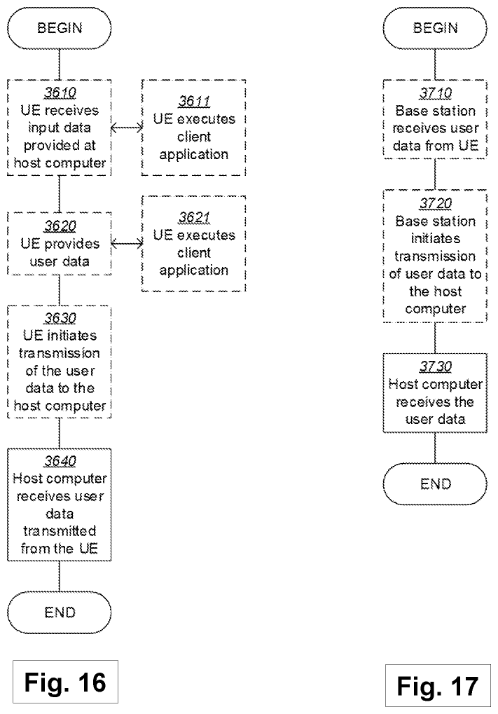

FIG. 17 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a radio network node for reducing energy consumption in communications with wireless devices in a wireless communication network, wherein the radio network node comprising a dual-polarized antenna array, which dual-polarized antenna array comprises a first sub-set antenna array and a second sub-set antenna array for communication with the wireless devices, the method comprising:
deciding whether to (a) deactivate or (b) not deactivate the second sub-set antenna array, to reduce the energy consumption, based on ongoing communications in the radio network node with wireless devices in the wireless communication network, the first sub-set antenna array and the second sub-set antenna array having a total antenna pattern that has a deviation that is below a threshold value.

2. The method according to claim 1, further comprising:
when (a) is decided based on that the ongoing data traffic in the radio network node with wireless devices in the wireless communication network is below a threshold value, deactivating the second sub-set antenna array and transmitting data and control information from the first sub-set antenna array; and
when (b) is decided based on that the ongoing data traffic in the radio network node with wireless devices in the wireless communication network is above a threshold value, transmitting the data and control information from the second sub-set antenna array.

3. The method according to claim 2, wherein (a) is decided, and wherein:
the transmitting of the data and control information from the first sub-set antenna array comprises transmitting the data in one part of the first sub-set antenna array and control information in the other part of the first sub-set antenna array.

4. The method according to claim 2, wherein (a) is decided, and wherein components of the first sub-set antenna array are a part of components of the dual-polarized antenna array, and wherein the components of the first sub-set antenna array are frequently changed to become another part of the components of the dual-polarized antenna array, and wherein:
the transmitting of the data and control information from the first sub-set antenna array is performed divided into time intervals from the first sub-set antenna array, each time interval using a changed part of the components of the dual-polarized antenna array.

5. The method according to claim 2, further comprising:
when (b) is decided based on that the ongoing data traffic in the radio network node with wireless devices in the wireless communication network is below a threshold value, transmitting the data from all parts of the second sub-set antenna array and the control information from a part of the second sub-set antenna array.

6. The method according to claim 1, wherein the second sub-set antenna array is a part of the first sub-set antenna array.

7. The method according to claim 1, wherein the first sub-set antenna array is smaller than the second sub-set antenna array.

8. The method according to claim 1, wherein the first sub-set antenna array is a prototype array and the second sub-set antenna array is an extended array.

9. The method according to claim 1, wherein the control information comprises any one out of: Synchronization Signal Block transmission, System Information transmission, paging, Random Access Response transmissions and broad-case services.

10. (canceled)

11. (canceled)

12. A radio network node for reducing energy consumption in communications with wireless devices in a wireless communication network, the radio network node comprising a dual-polarized antenna array, which dual-polarized antenna array comprises a first sub-set antenna array and a second sub-set antenna array for communication with the wireless devices, wherein the radio network node is configured to:
decide whether to (a) deactivate or (b) not deactivate the second sub-set antenna array, to reduce the energy consumption, based on ongoing communications in the radio network node with wireless devices in the wireless communication network, wherein the first sub-set antenna array and the second sub-set antenna array having total antenna pattern that has a deviation that is below a threshold.

13. The radio network node according to claim 12, further is configured to:
when (a) is decided based on that the ongoing data traffic in the radio network node with wireless devices in the wireless communication network is below a threshold value, deactivate the second sub-set antenna array and transmit data and control information from the first sub-set antenna array; and
when (b) is decided based on that the ongoing data traffic in the radio network node with wireless devices in the wireless communication network is above a threshold value, transmit the data and control information from the second sub-set antenna array.

14. The radio network node according to claim 13, wherein (a) is adapted to be decided, and wherein the network node further is configured to:
transmit the data and control information from the first sub-set antenna array by transmitting the data in one part of the first sub-set antenna array and control information in the other part of the first sub-set antenna array.

15. The radio network node according to claim 13, wherein (a) is configured to be decided, and wherein components of the first sub-set antenna array are a part of components of the dual-polarized antenna array, and wherein the components of the first antenna array are configured to be frequently changed to become another part of the components of the dual-polarized antenna array, and wherein the network node further is configured to:
transmit the data and control information from the first sub-set antenna array divided into time intervals from the first sub-set antenna array, each time interval using a changed part of the components of the dual-polarized antenna array.

16. The radio network node according to claim 13, further is configured to:
when (b) is decided based on that the ongoing data traffic in the radio network node with wireless devices in the wireless communication network is below a threshold value, transmit the data from all parts of the second sub-set antenna array and the control information from a part of the second sub-set antenna array.

17. The radio network node according to claim 12, wherein the second sub-set antenna array is a part of the first sub-set antenna array.

18. The radio network node according to claim 12, wherein the first sub-set antenna array is smaller than the second sub-set antenna array.

19. The radio network node according to claim 12, wherein the first sub-set antenna array is a prototype array and the second sub-set antenna array is an extended array.

20. The radio network node according to claim 12, wherein the control information comprises any one out of: Synchronization Signal Block transmission, System Information transmission, paging, Random Access Response transmission and broadcast services.

21. The radio network node according to claim 13, wherein the second sub-set antenna array is a part of the first sub-set antenna array.

22. The radio network node according to claim 13, wherein the first sub-set antenna array is smaller than the second sub-set antenna array.
